(19) United States
(12) Patent Application Publication
(10) Pub. No.: US 2009/0063676 A1
(43) Pub. Date: Mar. 5, 2009

(54) METHOD AND APPARATUS FOR PROVIDING STATUS INFORMATION BY UTILIZING PRESENCE SERVICE AND METHOD AND APPARATUS FOR GENERATING CONTENT STATUS INFORMATION BY UTILIZING PRESENCE SERVICE

(75) Inventors: Zhang-hoon OH, Suwon-si (KR); Eun NAMGUNG, Suwon-si (KR); Do-jun YANG, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/122,219

(22) Filed: May 16, 2008

(30) Foreign Application Priority Data
Aug. 30, 2007 (KR) 10-2007-0087679

(51) Int. Cl. G06F 15/173

(52) U.S. Cl. 709/224

(57) ABSTRACT

A method of and apparatus for providing status information by using presence information data, and a method of and apparatus for generating content status information are provided. The method of providing status information on a second user to a first user terminal which is used by a first user includes: inserting additional data into the status information on the second user requested by the first user terminal; and transmitting the status information on the second user into which the additional data is inserted to the first user terminal.

### CROSS-REFERENCE TO RELATED PATENT APPLICATIONS

This application claims priority from Korean Patent Application No. 10-2007-0087679, filed on Aug. 30, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to providing status information and generating status information, and more particularly, to providing status information by using presence information data, and generating content status information.

2. Description of the Related Art

With the rapid distribution of technologies related to the Internet a presence information display program for performing communication between a user and other users has recently been highlighted. The presence information display program supports status information on whether a person registered by a user can currently perform communication, which is to be displayed on a user terminal.

FIG. 1A is a diagram illustrating an example of a presence system according to related art technology.

The presence system according to the related art technology includes a presentity 110, a presence server 120, and a watcher 130.

The presentity 110 is a user providing status information, and transfers his or her status information to the presence server 120. In this case, the status information is data in a presence information data format (PIDF) which is used in the Request for Comments (RFC) 3863 standard. If the status of the user changes, the presentity 110 transfers the changed status to the presence server 120, thereby allowing the status of the user to be updated. The status information data in PIDF will be explained later with reference to FIG. 1B.

The presence server 120 stores the status information transferred from the presentity 110. Among status information items stored in the presence server 120, status information on a user requested by the watcher 130 is transferred to the watcher 130.

The watcher 130 requests status information of a desired user from the presence server 120, and receives the status information transmitted in response to the request. The watcher 130 may receive the status information of the desired user from the presence server 120 every time a predetermined period has elapsed or may receive updated status information whenever the status information is updated.

FIG. 1B is a diagram illustrating an example of the presence information data format (PIDF) defined in Request for Comments (RFC) 3863 according to related art technology.

The presence information data format 100 includes a declaration part 140 which includes an extensible markup language (XML) declaration and an encoding declaration.

The presence information data format 100 includes an ‘entity’ 150 which indicates the uniform resource locator (URL) of a presentity, meaning a user providing status information.

The presence information data format 100 includes at least one ‘tuple’ 160-1 or 160-2.

The presence information data format 100 includes at least one presence information item in relation to an identical presentity. The presence information means status information on the presentity.

The ‘tuple’ 160-1 or 160-2 plays a role of classifying a plurality of presence information items that an identical presentity has. For example, the presence information items may be classified according to apparatuses to which the presentity accesses, or according to applications that the presentity uses for accessing. Also, the presence information items may be classified according to time groups in which the presence information items are generated.

Each of the ‘tuples’ 160-1 and 160-2 has a unique ‘tuple id’ value in order to distinguish each ‘tuple’ 160-1 and 160-2.

In the current example, the presence information data format 100 includes a first tuple 160-1 and a second tuple 160-2, and will be explained focusing on the first tuple 160-1.

The first tuple 160-1 has at least one ‘status’ 170 as a lower level space.

The ‘status’ 170 indicates the status of a presentity corresponding to the first tuple 160-1. For example, if the ‘status’ 170 is ‘open’, an instant message can be transmitted to the presentity, and if the ‘status’ 170 is ‘closed’, an instant message cannot be transmitted to the presentity. Also, the ‘status’ 170 may express two or more overlapping statuses such as ‘open’ and ‘busy’.

The first tuple 160-1 can have ‘contact’ 180 as a lower level space. The ‘contact’ 180 may include address information for accessing presentity or may selectively include access priority. The access priority has a value in a range from 0 to 1, and a bigger number has higher priority.

The first tuple 160-1 may have at least one ‘note’ 190 as a lower level space.

The ‘note’ 190 includes information which relates to the presence information that a person can understand. The ‘note’ 190 may exist in a lower level space of the ‘tuple’ 160-1 or 160-2 or may exist in a lower level space of the presence information item.

The first tuple 160-1 can have at least one ‘timestamp’ 195 as a lower level space.

The ‘timestamp’ 195 indicates information on the time when presence information is generated.

In the related art presence information data format 100 indicating the status information of a user as described above, the status information of the user that can be expressed is limited. Also, it is impossible to add information such as audiovisual (A/V) data which is not defined by the standard and therefore application fields are limited.

In particular, the status information is generated in a user terminal, and after the status information is generated, status information cannot be added. As a result, it is impossible for a third party to use status information.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method of and apparatus for providing status information in order to expand an application scope of status information indicating the status of a user and to generate information on consumption details of content by using status information, and a method of and apparatus for generating content status information.

According to an aspect of the present invention, there is provided a method providing status information on a second user to a first user terminal which is used by a first user, the method including: inserting predetermined additional data into the status information on the second user requested by the first user terminal; and transmitting the status information on the second user into which the additional data is inserted to the first user terminal.

The method may further include receiving the status information on the second user requested by the first user terminal from a second user terminal.

The predetermined additional data may be address information on an address at which audiovisual (A/V) data additionally indicating the status of the second user is stored.

The predetermined additional data may be address information on an address at which advertisement data to be transmitted to the first user terminal is stored.

In the inserting of the additional data, information on the order in which the inserted additional data is to be reproduced in the first user terminal may be further inserted.

The first user terminal may be an Internet protocol television (IPTV).

The status information on the second user may be data in a PIDF complying with the RFC 2778 standard, and the first user may be a watcher of a presence model complying with the RFC 2778 standard, and the second user may be a presentity of a presence model complying with the RFC 2778 standard.

According to another aspect of the present invention, there is provided a method of generating in a server status information of content which is used by a user terminal, the method including: transmitting at least one of content and information on the content to the user terminal; receiving consumption detail information on consumption of the content in the user terminal from the user terminal; and generating the status information of the content based on the received consumption detail information.

The transmitting of the information on the content may include: inserting address information on an address at which the content is stored into the status information of the other user; and transmitting the status information of the other user, into which the address information on the address at which the content is stored is inserted, to the user terminal.

The status information on the other user may be data in PIDF complying with the RFC 2778 standard, and the user terminal may be a watcher of a presence model complying with the RFC 2778 standard, and the other user whose status information is requested by the user terminal may be a presentity of a presence model complying with the RFC 2778 standard.

The generating of the status information of the content may include: generating a virtual presentity corresponding to the content; and generating the presence information of the virtual presentity corresponding to the content based on the consumption details.

The consumption detail information may include at least one of information on whether the content has been downloaded to the user terminal, information on the number of times that the content has been reproduced by the user terminal, and information on the times when content has been reproduced in the user terminal.

According to another aspect of the present invention, there is provided a method of generating in a user terminal status information of content which is used by the user terminal, the method including: receiving at least one of content and information on the content from a server; extracting consumption detail information in the user terminal on the received content or the content obtained based on the information on the content; and generating the status information of the content based on the consumption detail information.

The information on the content may be address information on an address at which the content inserted into the status information of another user requested by the user terminal is stored.

The status information on the other user may be data in PIDF complying with the RFC 2778 standard, and the user terminal may be a watcher of a presence model complying with the RFC 2778 standard, and the other user whose status information is requested by the user terminal may be a presentity of a presence model complying with the RFC 2778 standard.

The generating of the status information of the content may include: generating a virtual presentity corresponding to the content; and generating the presence information of the virtual presentity corresponding to the content based on the consumption details.

The consumption detail information may include at least one of information on whether the content has been downloaded to the user terminal, information on whether the content has been deleted by the user terminal, information on the number of times that the content has been reproduced by the user terminal, and information on the times when content has been reproduced in the user terminal.

### BRIEF DESCRIPTION OF THE DRAWINGS

The above and other aspects of the present invention will become more apparent by describing in detail exemplary embodiments thereof with reference to the attached drawings in which:

FIG. 1A is a diagram illustrating an example of a presence system according to related art technology;

FIG. 1B is a diagram illustrating an example of PIDF defined in RFC 3863 according to related art technology;

FIG. 2 is a block diagram illustrating an apparatus for providing status information according to an exemplary embodiment of the present invention;

FIG. 3 is a block diagram illustrating a system including an apparatus for providing status information according to an exemplary embodiment of the present invention;

FIG. 4 is a diagram illustrating status information data into which address information on advertisement data is inserted according to an exemplary embodiment of the present invention;

FIG. 5 is a diagram illustrating status information data into which address information on audiovisual (A/V) data is inserted according to an exemplary embodiment of the present invention;

FIG. 6 is a diagram illustrating status information data into which information on reproduction order of inserted additional data is further inserted according to an exemplary embodiment of the present invention;

FIG. 7 is a block diagram illustrating an apparatus for generating content status information according to an exemplary embodiment of the present invention;

FIG. 8 is a diagram illustrating information on content which is transmitted in a transmission unit according to an exemplary embodiment of the present invention;

FIGS. 9A, 9B and 9C are diagrams illustrating status information data of content according to an exemplary embodiment of the present invention;

FIG. 10 is a block diagram illustrating a terminal apparatus for generating status information of content according to an exemplary embodiment of the present invention;

FIG. 11 is a flowchart illustrating a method of providing status information according to an exemplary embodiment of the present invention;

FIG. 12 is a flowchart illustrating a method of generating status information in a server according to an exemplary embodiment of the present invention;

FIG. 13 is a flowchart illustrating a method of generating status information in a terminal according to an exemplary embodiment of the present invention; and

FIGS. 14A and 14B are flowcharts illustrating a method of generating status information of content according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

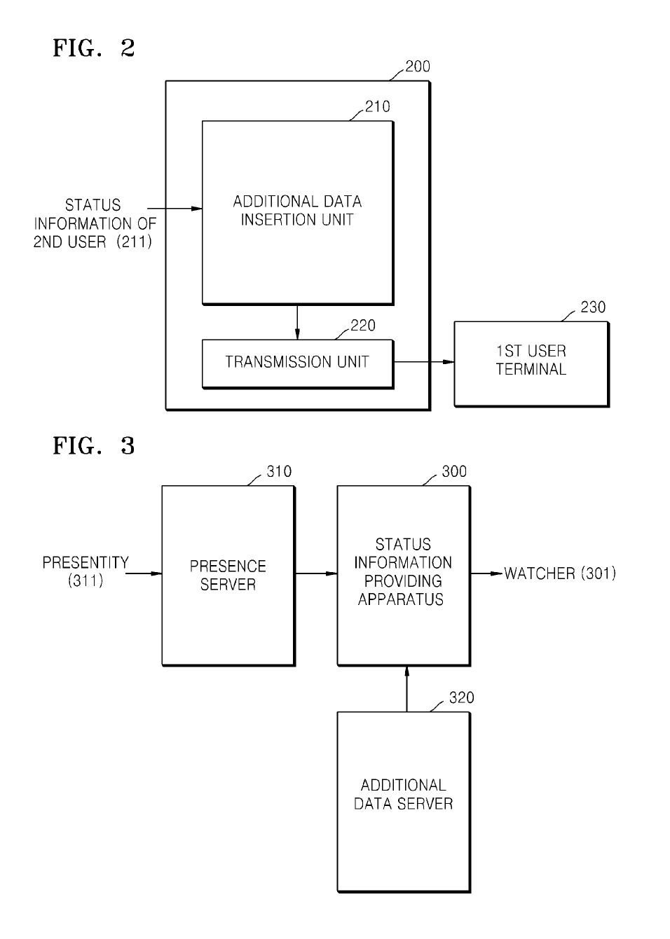

FIG. 2 is a block diagram illustrating an apparatus 200 for providing status information according to an exemplary embodiment of the present invention.

The apparatus 200 for providing status information according to the current exemplary embodiment is one that provides status information 211 on a second user to a first user terminal 230 which a first user uses, and includes an additional data insertion unit 210 and a transmission unit 220. In the description of the exemplary embodiments, the second user is a user providing his or her status information, and the first user is a user requesting the status information on the second user.

The additional data insertion unit 210 inserts predetermined additional data into the status information 211 on the second user requested by the first user terminal 230. The apparatus 200 for providing user status information may further include a status information reception unit (not shown) which receives status information on the second user from the second user terminal which the second user uses. When the apparatus 200 for providing user status information further includes the status information reception unit, the additional data insertion unit 210 receives the status information of the second user transmitted by the status information reception unit, and inserts predetermined additional data into the transmitted status information of the second user.

The predetermined additional data may be address information on an address at which advertisement data to be transmitted to the first user terminal 230 is stored. The advertisement data to be inserted may be advertisement data related to the second user and may also be arbitrary advertisement data. When address information on an address at which advertisement data is stored is inserted into the status information 211 on the second user, the first user terminal 230 may be a terminal that can reproduce advertisement data such as an Internet protocol television (IPTV). The first user terminal 230 can obtain advertisement data from the address information on an address at which advertisement data is stored. An exemplary embodiment of status information data into which address information on an address at which advertisement is stored is inserted will be explained later with reference to FIG. 3.

Predetermined additional data is A/V data related to the status of the second user, and can be data that additionally explains the status (for example, the current or future status) of the second user. In this case, the additional data insertion unit 214 receives transmitted A/V data related to the status of the second user. Predetermined additional data may be address information on an address at which A/V data related to the status of the second user is stored, and the first user terminal 230 can obtain A/V data from the address information on the address at which the A/V data is stored.

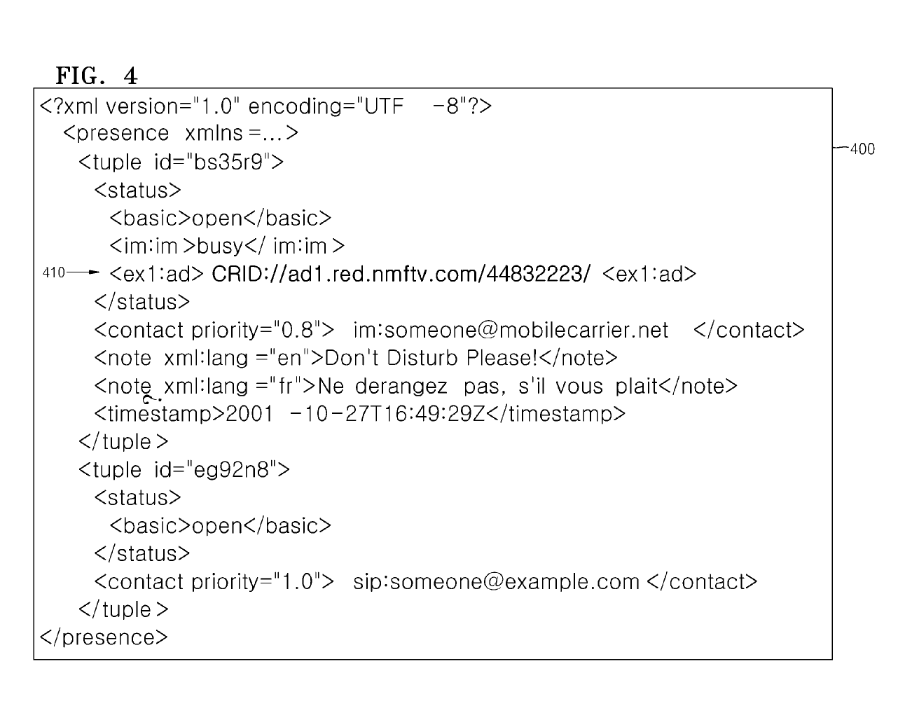

An exemplary embodiment of status information data into which address information on A/V data related to the status of the second user is inserted will be explained later with reference to FIG. 4.

The additional data insertion unit 210 may further insert information on the order in which inserted additional data is to be reproduced in the first user terminal 230. This assumes that the first user terminal 230 requests status information of a plurality of the other parties. In this case, a plurality of additional data items together with a plurality of status information items can be transmitted to the first user terminal 230. All the transmitted additional data items may not be able to be reproduced in the first user terminal 230, and even if all the additional data items can be reproduced, the reproduction order needs to be determined.

Information on the order in which the inserted additional data is to be reproduced in the first user terminal 230 may be at least one of marks obtained using inserted additional data or the reproduction order.

According to exemplary embodiments, a variety of methods of calculating a mark obtained using inserted additional data may exist. For example, when the additional data is an advertisement, the mark obtained using the inserted additional data may be calculated based on the number of inserted additional data items, the number of users requesting the status information, an kind of access device for connecting to the second user, the number of times of updating status information of the second user, and the success rate of accessing the second user.

It can be assumed that the probability that additional data is reproduced in the first user terminal is high when the number of additional data items is big, the number of users requesting the status information is big, the number of times of updating the status information of the second user is big, or the success rate of accessing the second user is high. Accordingly, the additional data having such conditions obtains a high score. Also, different marks can be given to additional data according to devices for accessing the second user. For example, when the second user is connected through a wireless local area network (WLAN), a high score can be given relative to when the second user is connected through a telephone line.

The first user terminal 230 can determine the reproduction order based on the marks assigned to the received additional data items. Also, the first user terminal 230 may simply transfer the list of the received additional data items, and the reproduction order may be calculated in the server based on the marks of the additional data items on the list. Based on the calculated order, the additional data items may be reproduced in the first user terminal 230 or may be made to wait in the storage space of the first user terminal 230.

According to this method, an additional data item obtaining a high score has a high probability of being reproduced in the user terminal. When additional data is advertisement data, as an advertisement data item obtains a higher score, it has a higher advertisement effect. Accordingly, the advertiser of the advertisement data can divide the profit generated by reproducing of advertisement with the second user so that the second user can be induced to frequently update his or her status information in order to make the score of the additional data inserted into the status information of the second user higher.

An exemplary embodiment of status information data into which information on the reproduction order of inserted additional data items is inserted will be explained later with reference to FIG. 6.

The transmission unit 220 transmits the status information 211 on the second user into which additional data has been inserted to the first user terminal 230.

FIG. 3 is a block diagram illustrating a system including an apparatus 300 for providing status information according to an exemplary embodiment of the present invention.

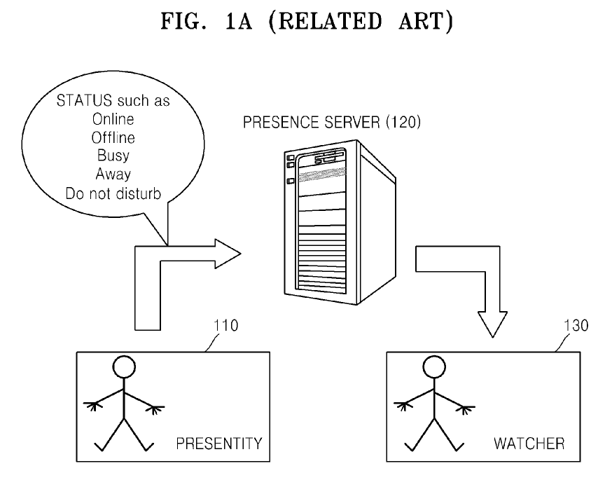

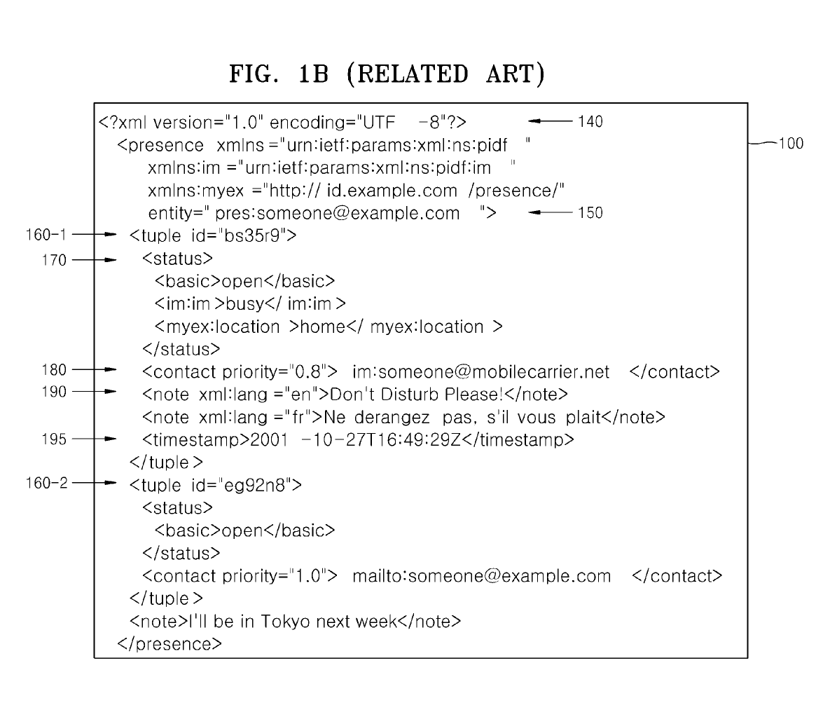

A presence server 310 receives status information data in PIDF transmitted from a presentity 311 and stores the data. An example of status information data in PIDF is as described above with reference to FIG. 1B.

The presence server 310 transfers the status information of the presentity 311 requested by a watcher 301 to the apparatus 300 for providing status information.

An additional data server 320 stores additional data to be inserted into status information data in PIDF, and transmits appropriate additional data to the apparatus 300 for providing status information. The additional data server 320 may store information on an address at which advertisement content is stored, and information on an address at which A/V data for additionally expressing the status of the presentity 311 is stored, or may directly store the advertisement content and A/V data.

The apparatus 300 for providing status information receives status information data in PIDF transmitted from the presence server 310, and receives additional data transmitted from the additional data server 320. The apparatus 300 for providing status information inserts the received additional data into the status information data in PIDF transmitted by the presence server 310, thereby converting it into new status information data. The new status information data into which the additional data is inserted is transmitted to the watcher 301 requesting the data.

In the current exemplary embodiment, the apparatus 300 for providing status information may further include a user capacity information acquisition module (not shown) and a communication module (not shown).

The user capacity information acquisition module collects information on the capacity of a user terminal used by the watcher 301 to reproduce content, and makes appropriate additional data be inserted into status information. For example, when a terminal used by the watcher 301 is an IPTV, the terminal can reproduce advertisement content, and therefore, advertisement content or address information related to advertisement content can be inserted as additional data into status information data. However, when a terminal is a mobile phone, and advertisement content cannot be reproduced, advertisement content or address information related to the advertisement content is not inserted as additional information into the status information data.

The communication module is a module for connecting to an external communication network, thereby receiving additional data. Though the current exemplary embodiment includes the additional data server 320, if the additional data server 320 is not included, the apparatus 300 for providing status information can obtain appropriate additional data from an external communication network such as the Internet through the communication module.

The apparatus 300 for providing status information may be implemented separately from the presence server 310 and the additional data server 320, the apparatus 300 for providing status information may be implemented so as to include both the presence server 310 and the additional data server 320.

FIG. 4 is a diagram illustrating status information data 400 into which address information 410 on advertisement data is inserted according to an exemplary embodiment of the present invention.

The structure of the status information data 400 according to the current exemplary embodiment is the same as the structure of the status information illustrated in FIG. 1B except that address information 410 on advertisement data is inserted, and therefore the explanation will be omitted here.

In the current exemplary embodiment, the address information 410 on the advertisement data inserted into the status information data 400 is a URL address of a website. If the status information data 400 into which the address information 410 for the advertisement data is inserted is transmitted to a user terminal, the user terminal obtains the advertisement data from the address information 410 on the advertisement data by using an external communication network. The external communication network used by the user terminal may be a variety of external communication networks such as CDMA, WLAN, and WiBro networks.

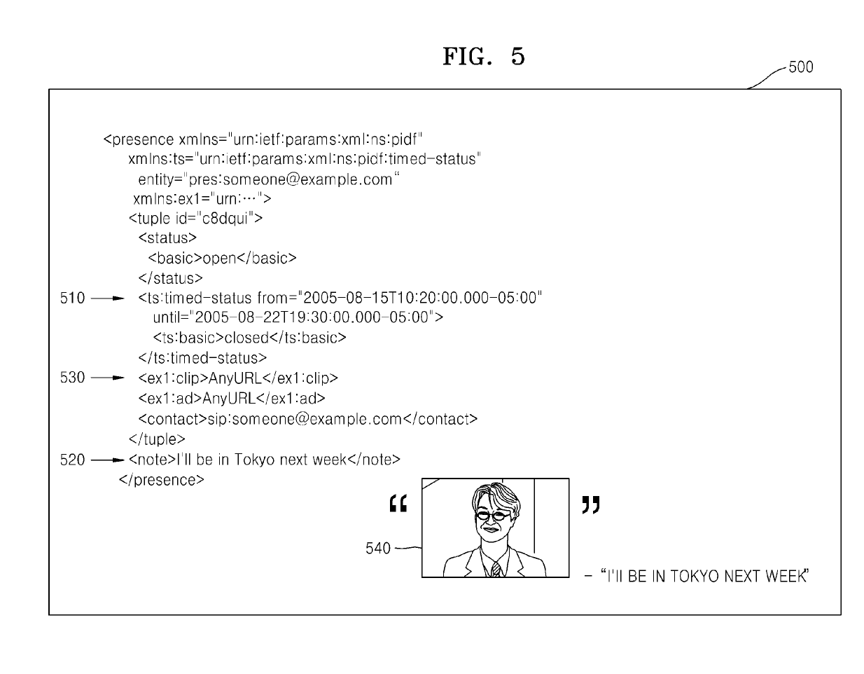

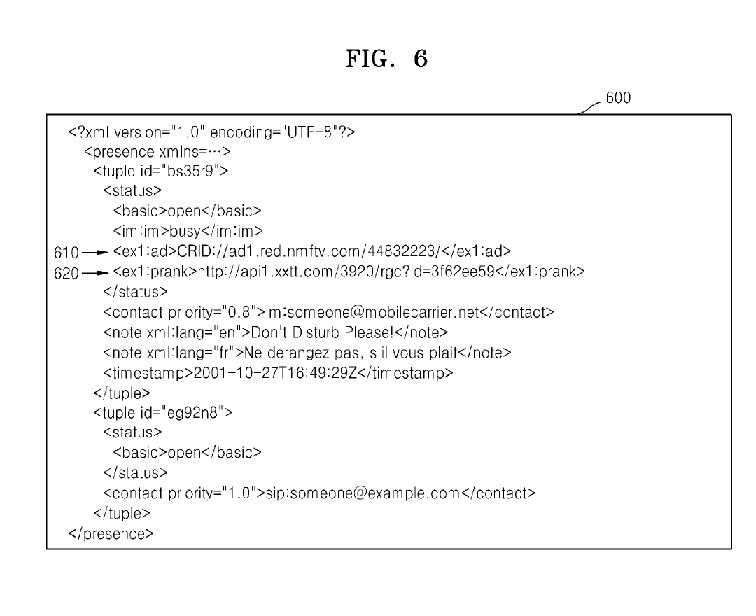

FIG. 5 is a diagram illustrating status information data 500 into which address information 530 on A/V data is inserted according to an exemplary embodiment of the present invention.

The structure of the status information data 500 according to the current exemplary embodiment is the same as the structure of the status information illustrated in FIG. 1B except that address information 530 on the status information 510 for the future and address information 530 related to A/V data 540 are inserted, and therefore the explanation will be omitted here.

In the current exemplary embodiment, the status information 510 for the future indicates that an instance message cannot be sent in a period “2005-08-15 10:20 2005-08-22 19:30”. Also, ‘note’ information 520 is ‘I'll be in Tokyo next week’, indicating that the user would be in Tokyo the following week.

The A/V data 540 additionally indicates the status information 510 for the future. If status information data 500 into which address information 530 related to A/V data is inserted is transmitted to a user terminal, the user terminal obtains A/V data from the address information 530 related to the A/V data 540 by using an external communication network. The obtained A/V data 540 may be downloaded into a storage space in the user terminal or may be reproduced in a streaming format.

FIG. 6 is a diagram illustrating status information data 600 into which information 620 on reproduction order of inserted additional data is further inserted according to an exemplary embodiment of the present invention.

The structure of the status information data 600 according to the current exemplary embodiment is the same as the structure of status information illustrated in FIG. 1 except that address information 610 of advertisement data and information 620 on the reproduction order are inserted, and therefore the explanation will be omitted here.

In the current exemplary embodiment, the address information 610 related to the advertisement data inserted into the status information data 600 is a URL address of a website.

The information 620 on the reproduction order may be a score on the inserted advertisement data or the order itself, or may be a URL address of a website providing score or order information.

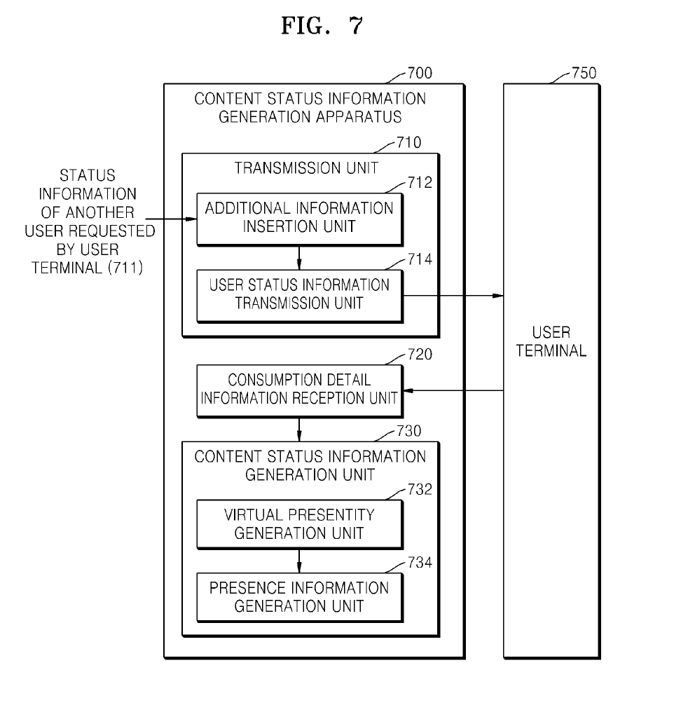

FIG. 7 is a block diagram illustrating an apparatus 700 for generating content status information according to an exemplary embodiment of the present invention.

The apparatus 700 for generating content status information according to the current exemplary embodiment includes a transmission unit 710, a consumption detail information reception unit 720, and a content status information generation unit 730.

The transmission unit 710 transmits at least one of content and information on the content to a user terminal 750. The types of content on which status information is provided are not limited, and may be advertisement data or A/V content. The transmission unit 710 may transmit content itself to the user terminal 750 or when the user terminal 750 is connected to an external communication network, the transmission unit 710 may transmit only information on content, thereby allowing the user terminal 750 to obtain the content through the external communication network.

For example, information on content may be address information on an address at which the content is stored. A variety of methods of providing address information of content exist. As illustrated in FIG. 2, the address information of content may be inserted into the status information 711 of another user requested by the user terminal 750. In this case, the transmission unit 710 includes an additional information insertion unit 712 and a user status information transmission unit 714. The status information 711 of the other user requested by the user terminal 750 may be data in PIDF complying with the RFC 2778 standard, and in this case, the user terminal 750 corresponds to a watcher, and the other user whose status information is requested by the user terminal 750 corresponds to a presentity.

The additional information insertion unit 712 inserts address information on an address at which the status information 711 on the other user requested by the user terminal 750 is stored.

The user status information transmission unit 714 transmits the status information 711 on the other user requested by the user terminal 750 into which the address information on the address at which the content is stored to the user terminal 750.

The consumption detail information reception unit 720 receives consumption detail information from the user terminal 750 on content from the user terminal 750.

The consumption detail information may include at least one of information on whether download of content to the user terminal 750 has been completed, information on whether content has been deleted in the user terminal 750 intentionally by the user, information on the number of times of reproducing content in the user terminal 750, and information on the times when content has been reproduced in the user terminal 750. Also, all information indicating consumption details of content, such as information on whether reproduction of content was completed from the beginning to the end, and information on whether reproduction of content was forcibly finished in the middle of the reproduction, can be included. In addition, information on the user terminal 750 in which content is used can be included.

The content status information generation unit 730 generates status information on content based on the consumption detail information.

The content status information generation unit 730 may include a virtual presentity generation unit 732, and a presence information generation unit 734.

The virtual presentity generation unit 732 generates a virtual presentity corresponding to content. In general, the presentity means a user providing status information as described above with reference to FIG. 1A. However, in the present specification, the presentity means content providing its status information. In the current exemplary embodiment, the virtual presentity generation unit 732 receives consumption detail information on content transmitted by the user terminal 750, and then, generates a virtual presentity corresponding to the content. However, before the transmission unit 710 transmits content or information on the content, the transmission unit 710 may generate a presentity corresponding to the content in advance.

The presence information generation unit 734 generates presence information indicating status information on a virtual presentity corresponding to content, based on the consumption detail information transmitted by the consumption detail information reception unit 720. Since content is set as a virtual presentity in the present specification, the presence information on the virtual presentity ultimately indicates the status information on the content.

For example, when the status information of a user ‘A’ is ‘absent’, the user ‘A’ providing status information corresponds to a presentity, and ‘absent’ corresponds to the presence information. Similarly, it is assumed that ‘hero’ is generated as a virtual presentity corresponding to content ‘hero.avi’ and ‘hero.avi’ is ‘downloaded, and then reproduced once, and then deleted’. In this case, ‘hero’ providing status information corresponds to a presentity, and ‘downloaded, and then reproduced once, and then deleted’ corresponds to the presence information of ‘hero’.

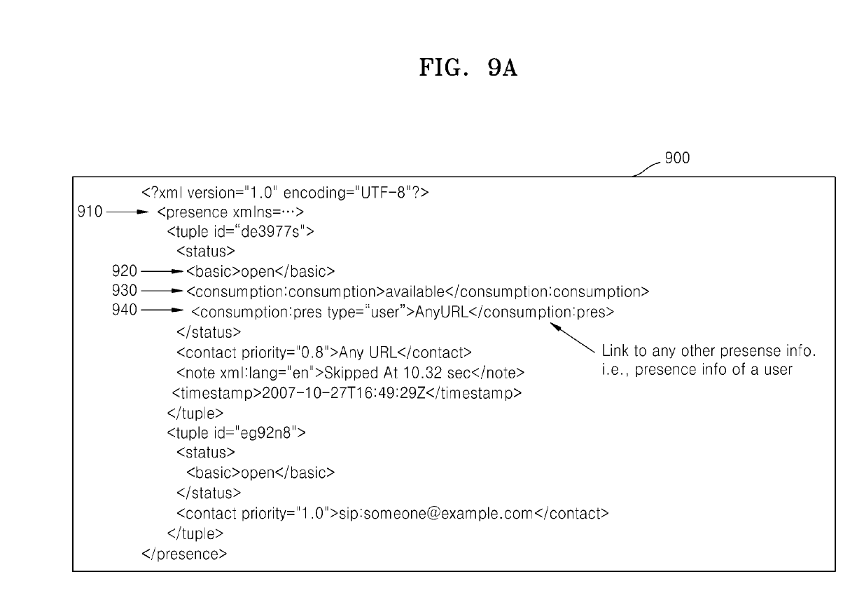

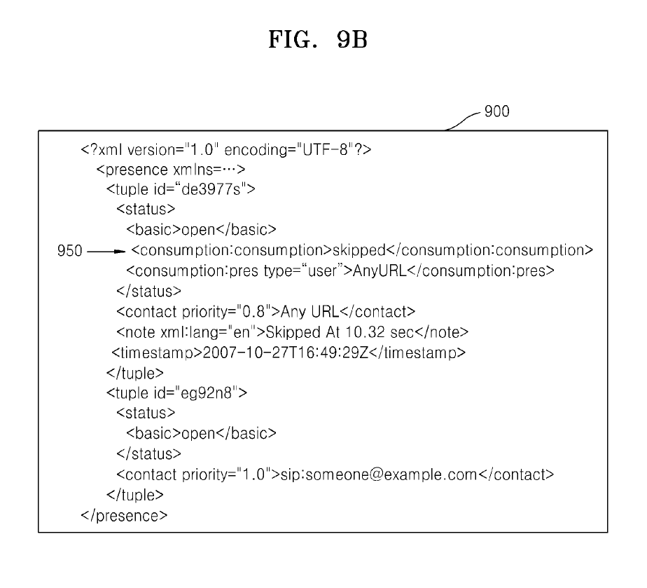

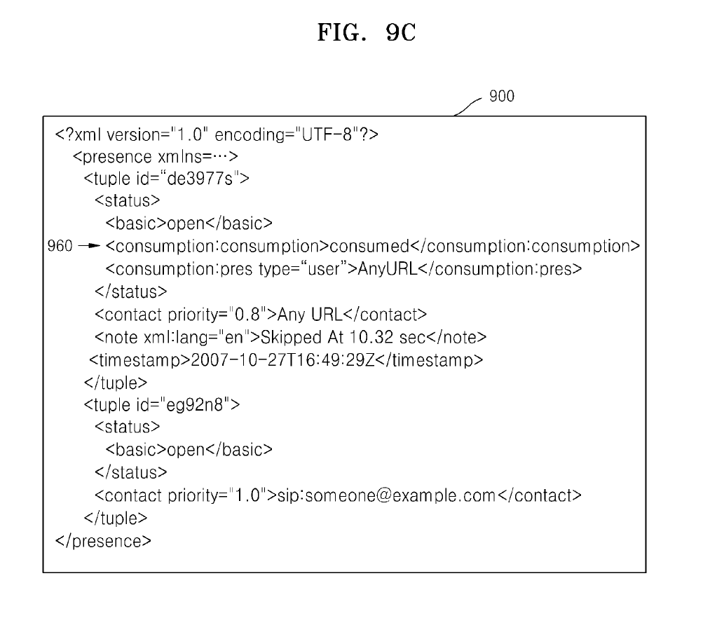

An exemplary embodiment of status information data of content generated according to the present invention will be explained later with reference to FIG. 9.

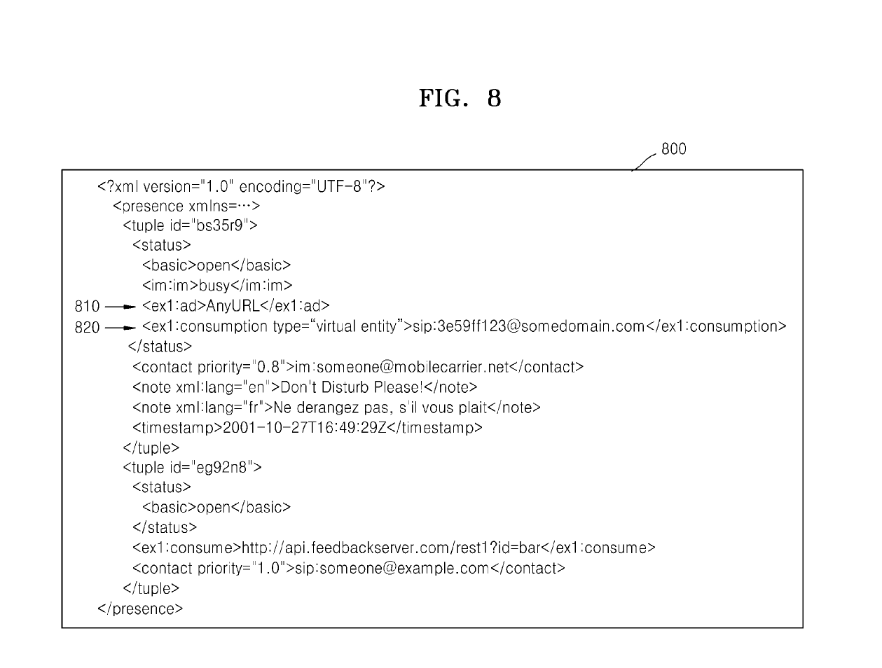

FIG. 8 is a diagram illustrating information on content which is transmitted from the transmission unit 710 according to an exemplary embodiment of the present invention.

In the current exemplary embodiment, the address information 810 on content is inserted into status information data 800 of another user requested by the user terminal 750 and then transmitted.

Since the structure of the status information data 800 of the other user requested by the user terminal 750 is the same as the structure of the status information described above with reference to FIG. 1, except for the inclusion of the address information 810 on the content and virtual presentity information 820, the explanation will be omitted here.

The address information 810 inserted into the status information data 800 is a URL address of a website.

The virtual presentity information 820 means a virtual presentity corresponding to content, and in the current exemplary embodiment, before information 810 on content is transmitted through the transmission unit 710, a virtual presentity corresponding to the content should be generated. However, as described above with reference to FIG. 7, the virtual presentity corresponding to the content may be generated in the content status information generation unit 730 after the consumption detail information on the content is received from the user terminal 750.

FIGS. 9A, 9B and 9C are diagrams illustrating status information data of content according to an exemplary embodiment of the present invention.

Since the structure of content status information data 900 according to the current exemplary embodiment is the same as the structure of status information described above with reference to FIG. 1B, except for the inclusion of ‘status’ (920˜940), the explanation will be omitted here.

Referring to FIG. 9A, ‘presence xmlns’ 910 indicates information on a virtual presentity corresponding to content.

Whether the content is downloaded to a storage space in the user terminal 750 can be indicated by ‘basic’ 920. In the current exemplary embodiment, ‘open’ means that the content has been downloaded to the storage space in the user terminal 750.

Consumption details of the content in the user terminal 750 can be indicated by ‘consumption:consumption’ 930. In the current exemplary embodiment, ‘available’ means that the content is available in the user terminal 750.

In order to identify the user terminal 750 receiving the content, ‘consumption:pres type’ 940 is used.

Referring to FIG. 9B, ‘consumption:consumption’ 950 is ‘skipped’ and this indicates that the reproduction is finished in the middle of reproducing the content in the user terminal 750.

Referring to FIG. 9C, ‘consumption: consumption’ 960 is ‘consumed’ and this indicates that the content is fully reproduced in the user terminal 750.

In the current exemplary embodiment, information on whether the content has been downloaded and information on whether the content has been reproduced are used as consumption detail information. However, information on the number of times of reproduction or information on whether the content has been deleted may be further inserted.

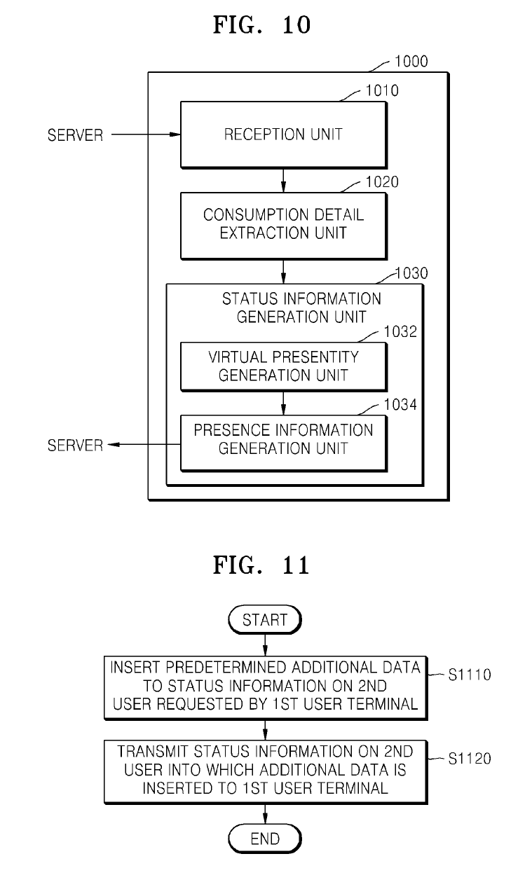

FIG. 10 is a block diagram illustrating a terminal apparatus 1000 for generating status information of content according to an exemplary embodiment of the present invention.

The terminal apparatus 1000 for generating status information on content according to the current exemplary embodiment includes a reception unit 1010, a consumption detail extraction unit 1020, and a status information generation unit 1030.

The reception unit 1010 receives at least one of content and information on the content. The content or the information on the content to be received can be transmitted from a server.

The consumption detail extraction unit 1020 extracts consumption detail information on the obtained content in the terminal apparatus 1000 based on the content or the information on the content received by the reception unit 1010.

The content status information generation unit 1030 generates the status information on the content based on the consumption detail information.

The content status information generation unit 1030 includes a virtual presentity generation unit 1032 and a presence information generation unit 1034.

The virtual presentity generation unit 1032 generates a virtual presentity corresponding to the content. If virtual presentity information corresponding to content is included in the information on the content received by the reception unit 1010, the virtual presentity generation unit 1032 may be omitted.

The presence information generation unit 1034 generates the presence information of a virtual presentity corresponding to content based on the consumption details of the content. If virtual presentity information corresponding to content is included in the information on the content received by the reception unit 1010, presence information is generated based on the received presentity information and the content consumption detail information.

FIG. 11 is a flowchart illustrating a method of providing status information according to an exemplary embodiment of the present invention.

In operation S1110, predetermined additional data is inserted into status information on a second user requested by a first user terminal. A variety of the predetermined additional data inserted into the status information may exist, including address information on an address at which A/V data related to the status of the second user or address information on advertisement data to be transmitted to the first user terminal is stored. Also, information on the order in which the inserted additional data is to be reproduced in the first user terminal may be further inserted.

In operation S1210, the status information of the second user into which the additional information is inserted is transmitted to the first user terminal.

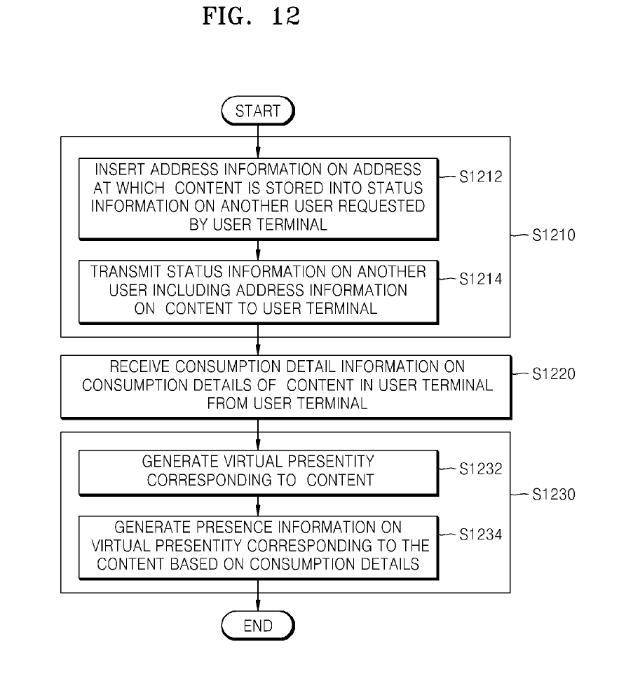

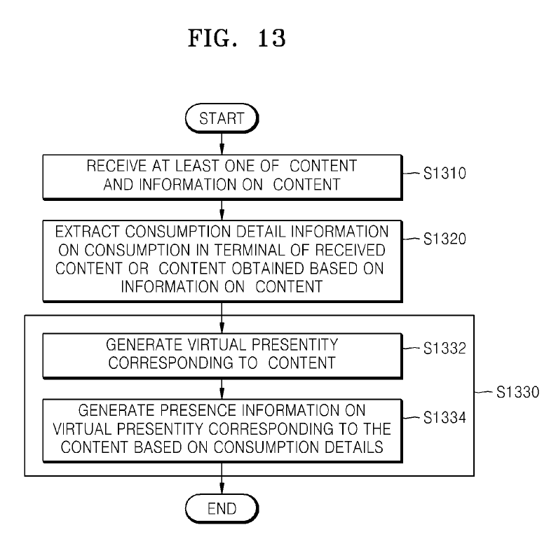

FIG. 12 is a flowchart illustrating a method of generating status information in a server according to an exemplary embodiment of the present invention.

In operation S1210, at least one of content and information on the content is transmitted to a user terminal.

Operation S1210 can be implemented as operations S1212 and S1214.

In operation S1212, address information on an address at which content is stored is inserted into the status information of another user requested by a user terminal.

In operation S1214, the status information on the other user including the address information on the content is transmitted to the user terminal.

In operation S1220, consumption detail information on the consumption details of the content in the user terminal is received from the user terminal.

In operation S1230, the status information on the content is generated based on the received consumption detail information.

Operation S1230 can be implemented as operations S1232 and S1234.

In operation S1232, a virtual presentity corresponding to content is generated.

In operation S1234, the presence information of the virtual presentity corresponding to the content is generated based on the consumption details.

Also, the present exemplary embodiment may further include an operation for transmitting the generated status information on the content to another user terminal requesting the status information.

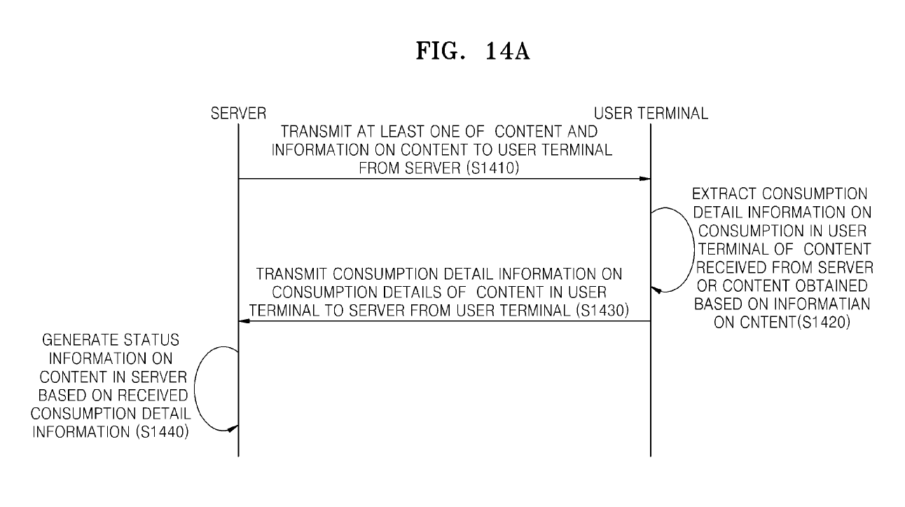

FIG. 13 is a flowchart illustrating a method of generating status information in a terminal according to an exemplary embodiment of the present invention.

In operation S1310, at least one of content and information on the content is received. The information on the content may be address information on an address at which content inserted into the status information of another user requested by the terminal is stored.

In operation S1320, consumption detail information from the terminal on the received content or the content obtained based on the information on the content is extracted.

In operation S1330, the status information of the content is generated based on the consumption detail information.

Operation S1330 can be implemented as operations S1332 and S1334.

In operation S1332, a virtual presentity corresponding to content is generated.

In operation S1334, the presence information on the virtual presentity corresponding to the content is generated based on the consumption details.

An operation for transmitting the generated content status information to a server may further be included. Also, the status information on the content transmitted to the server may be transferred to another user who wants the status information on the content.

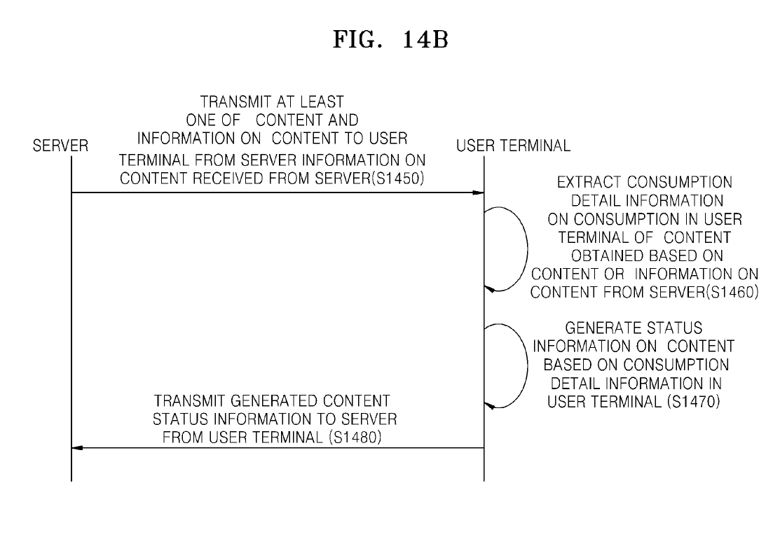

FIG. 14A is a flowchart illustrating a method of generating status information on content in a server according to an exemplary embodiment of the present invention.

In operation S1410, at least one of content and information on the content is transmitted to a user terminal from a server.

In operation S1420, consumption detail information on consumption in the user terminal of the content received from the server or the content obtained based on the information on the content is extracted.

In operation S1430, the consumption detail information on the consumption of the content in the user terminal is transmitted to the server from the user terminal.

In operation S1440, the status information on the content is generated in the server based on the received consumption detail information.

FIG. 14B is a flowchart illustrating a method of generating status information on content in a user terminal according to an exemplary embodiment of the present invention.

In operation S1450, at least one of content and information on the content is transmitted to a user terminal from a server.

In operation S1460, consumption detail information on consumption in the user terminal of the content received from the server or the content obtained based on the information on the content is extracted.

In operation S1470, the status information on the content is generated in the user terminal based on the consumption detail information.

In operation S1480, the generated status information on the content is transmitted to the server from the user terminal.

According to the exemplary embodiments of the present invention, additional data is inserted into status information and transmitted, thereby expanding the application scope of the status information.

Also, by generating status information with respect to content, the consumption details, frequency and the like of the content can be fed back and utilized through transmission.

The present invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method providing status information on a second user to a first user terminal which is used by a first user, the method comprising:
inserting additional data into the status information on the second user requested by the first user terminal; and
transmitting the status information on the second user into which the additional data has been inserted, to the first user terminal.

2. The method of claim 1, further comprising receiving the status information on the second user requested by the first user terminal from a second user terminal.

3. The method of claim 1, wherein the additional data comprises address information on an address at which audio or visual data additionally indicating a status of the second user is stored.

4. The method of claim 1, wherein the additional data is address information on an address at which advertisement data to be transmitted to the first user terminal is stored.

5. The method of claim 1, wherein in the inserting the additional data, information on an order in which the inserted additional data is to be reproduced in the first user terminal is further inserted.

6. The method of claim 1, wherein the first user terminal is an Internet protocol television.

7. The method of claim 1, wherein the status information on the second user comprises data in a presence information data format complying with the Request for Comments (RFC) 2778 standard, and the first user is a watcher of a presence model complying with the RFC 2778 standard, and the second user is a presentity of a presence model complying with the RFC 2778 standard.

8. A method of generating in a server status information on content which is used by a user terminal, the method comprising:
transmitting to the user terminal at least one of content and information on the content;
receiving from the user terminal consumption detail information on consumption of the content in the user terminal; and
generating the status information on the content based on the received consumption detail information.

9. The method of claim 8, wherein the transmitting the information on the content comprises:
inserting address information on an address at which the content is stored into the status information of another user; and
transmitting to the user terminal the status information of the other user into which the address information on the address at which the content is stored is inserted.

10. The method of claim 9, wherein the status information on the other user comprises data in presence information data format complying with the Request for Comments (RFC) 2778 standard, and the user terminal is a watcher of a presence model complying with the RFC 2778 standard, and the other user whose status information is requested by the user terminal is a presentity of a presence model complying with the RFC 2778 standard.

11. The method of claim 9, wherein the generating the status information on the content comprises:
generating a virtual presentity corresponding to the content; and
generating the presence information on the virtual presentity corresponding to the content based on the consumption details.

12. The method of claim 8, wherein the consumption detail information comprises at least one of information on whether the content has been downloaded to the user terminal, information on a number of times that the content has been reproduced by the user terminal, and information on the times when content has been reproduced in the user terminal.

13. A method of generating in a user terminal status information on content which is used by the user terminal, the method comprising:
receiving from a server at least one of content and information on the content;
extracting consumption detail information in the user terminal on the received content or the content obtained based on the information on the content; and
generating the status information on the content based on the consumption detail information.

14. The method of claim 13, wherein the information on the content comprises address information on an address at which the content inserted into the status information of another user requested by the user terminal is stored.

15. The method of claim 14, wherein the status information on the other user is data in presence information data format complying with the Request for Comments (RFC)2778 standard, and the user terminal is a watcher of a presence model complying with the RFC 2778 standard, and the other user whose status information is requested by the user terminal is a presentity of a presence model complying with the RFC 2778 standard.

16. The method of claim 13, wherein the generating the status information on the content comprises:
generating a virtual presentity corresponding to the content; and
generating the presence information of the virtual presentity corresponding to the content based on the consumption details.

17. The method of claim 13, wherein the consumption detail information comprises at least one of information on whether the content has been downloaded to the user terminal, information on whether the content has been deleted by the user terminal, information on a number of times that the content has been reproduced by the user terminal, and information on the times when content has been reproduced in the user terminal.

18. An apparatus for providing status information on a second user to a first user terminal which is used by a first user, the apparatus comprising:
an additional data insertion unit which inserts additional data into the status information on the second user requested by the first user terminal; and
a transmission unit which transmits the status information on the second user into which the additional data has been inserted to the first user terminal.

19. The apparatus of claim 18, further comprising a status information reception unit which receives the status information on the second user requested by the first user terminal from a second user terminal.

20. The apparatus of claim 18, wherein the additional data is address information on an address at which advertisement data to be transmitted to the first user terminal is stored.

21. The apparatus of claim 18, wherein the status information on the second user is data in a presence information data format complying with the Request for Comments (RFC) 2778 standard, and the first user terminal is a watcher of a presence model complying with the RFC 2778 standard, and the second user is a presentity of a presence model complying with the RFC 2778 standard.

22. An apparatus for generating in a user terminal status information of content which is used by the user terminal, the apparatus comprising:
a reception unit which receives at least one of content and information on the content from a server;
a consumption detail information extraction unit which extracts consumption detail information in the user terminal on the received content or the content obtained based on the information on the content; and
a content status information generation unit which generates the status information on the content based on the consumption detail information.

23. The apparatus of claim 22, wherein the information on the content is address information on an address at which the content inserted into the status information of another user requested by the user terminal is stored.

24. The apparatus of claim 22, wherein the status information on the other user is data in presence information data format complying with the Request for Comments (RFC) 2778 standard, and the user terminal is a watcher of a presence model complying with the RFC 2778 standard, and the other user whose status information is requested by the user terminal is a presentity of a presence model complying with the RFC 2778 standard.

25. The apparatus of claim 24, wherein the content status generation unit comprises:
a virtual presentity generation unit which generates a virtual presentity corresponding to the content; and
a presence information generation unit which generates the presence information of the virtual presentity corresponding to the content based on the consumption details.
